(19) United States
(12) Patent Application Publication
(10) Pub. No.: US 2009/0059022 A1
(43) Pub. Date: Mar. 5, 2009

(54) IMAGE PICKUP APPARATUS, IMAGE PICKUP METHOD, AND PROGRAM

(75) Inventor: Kentaro Tanaka, Kawaski-shi (JP)

Correspondence Address: COWAN LIEBOWITZ & LATMAN P.C.;JOHN J TORRENTE, 1133 AVE OF THE AMERICAS, NEW YORK, NY, 10036, US

(73) Assignee: Canon Kabushiki Kaisha, Ohta-ku Tokyo (JP)

(21) Appl. No.: 11/911,827

(22) PCT Filed: Jan. 22, 2007
(86) PCT No.: PCT/JP2007/051325

§ 371 Date: Oct. 18, 2007

(30) Foreign Application Priority Data
Jan. 23, 2006 (JP) 2006-014300
Dec. 26, 2006 (JP) 2006-356091

(51) Int. Cl. H04N 5/228; H04N 5/91

(52) U.S. Cl. 348/222.1; 386/68; 348/E05.031; 386/E05.001

(57) ABSTRACT

An image pickup apparatus includes: an image pickup unit adapted to shoot an object; an image processing unit adapted to execute image processing to an image data obtained from the image pickup unit to obtain an processed image data; a recording unit adapted to record both the image data obtained from the image pickup unit and the processed image data as related image data; and a display control unit adapted to control to display the processed image data recorded by the recording unit on a display unit, and to control not to display on the display unit the image data related to the processed image data.

### TECHNICAL FIELD

The present invention relates to an image pickup apparatus, image pickup method, and program for shooting, recording and reproducing still images and moving images.

### BACKGROUND ART

Cameras that use an image sensor comprising a semiconductor constituted by a CCD (Charge-Coupled Device) or the like have recently come into widespread use in place of cameras that employ silver-salt film. Cameras of this kind, which are adapted to record image data on a recording medium electronically and display images using a display device such as an LCD (Liquid Crystal Display) device, are being marketed as so-called digital cameras. With such a digital camera, it is possible to display images, which are represented by image data that has been captured and recorded on a recording medium, on a display unit integrated with the digital camera or on an image display unit externally connected to the camera.

Image pickup apparatuses such as digital cameras include those of the type equipped with a continuous shooting function referred to as “continuous shooting”, making it possible to record a series of images represented by the image data. The following functions are known as functions for recording a series of mutually related image data successively on a recording medium: Stitch shooting is a function for performing shooting premised on overlapping of a plurality of image data in a series. Also available are user-mode shooting for applying specific image conversion processing to image data obtained in a series of shooting operations, and bracket shooting for performing continuous shooting while changing shooting conditions. Thus, as seen from the user, there are cases where a series of shooting operations are performed or where a plurality of items of image data are captured and recorded as mutually related image data. In a case where a series of image data obtained by shooting in such a shooting mode is recorded on a recording medium, the series of image data is recorded, reproduced and printed as a single item of image data without distinguishing among the related items of image data.

A known method of distinguishing and reproducing image data as related image data in an image pickup apparatus is described in the specification of JPA2000-276582. According to this prior art, image data of different file formats recorded on a recording medium is read from the recording medium and reproduced while the image data is distinguished on a per-file-format basis.

Consider a case where a plurality of related items of image data recorded on a recording medium are reproduced. In such case, neither a method of reproducing only related image data generated by a series of shooting operations nor a method of reproducing only image data that has been subjected to specific image conversion processing and recorded has been proposed. Accordingly, the conventionally proposed image pickup apparatus is incomplete in terms of the reproducing function. Further, assume that a user has performed an operation in a shooting mode in which specific image conversion processing is applied to original image data in a single shooting operation and a plurality of items of image data that have undergone image conversion processing are generated. In this case, there have been no proposals regarding a method whereby image data, which has undergone the image conversion processing and been recorded on a recording medium, is referred to at the time of reproducing.

### DISCLOSURE OF INVENTION

The present invention provides image processing that is useful in an image pickup apparatus that handles related image data generated by a series of shooting operations.

In order to solve the problems mentioned above, one aspect of the present invention provides an image pickup apparatus which comprises:

an image pickup unit adapted to shoot an object;

an image processing unit adapted to execute image processing to an image data obtained from the image pickup unit to obtain an processed image data;

a recording unit adapted to record both the image data obtained from the image pickup unit and the processed image data as related image data; and

a display control unit adapted to control to display the processed image data recorded by the recording unit on a display unit, and to control not to display on the display unit the image data related to the processed image data.

In order to solve the problems mentioned above, another aspect of the present invention provides an image pickup method which comprises:

an image pickup step adapted to shoot an object;

an image processing step adapted to execute image processing to an image data obtained at the image pickup step to obtain an processed image data;

a recording step adapted to record both the image data obtained from the image pickup step and the processed image data as related image data; and

a display control step adapted to control to display the processed image data recorded at the recording step on a display unit, and to control not to display on the display unit the image data related to the processed image data.

In accordance with the present invention, it is possible to provide an image pickup apparatus that handles related image data generated by a series of shooting operations.

Further features of the present invention will become apparent from the following description of exemplary embodiments with reference to the attached drawings.

### BRIEF DESCRIPTION OF DRAWINGS

FIG. 1 is a block diagram of an image pickup apparatus according to a first embodiment of the present invention;

FIG. 2 is a flowchart of a main routine of an image pickup apparatus in first and second embodiments of the present invention;

FIG. 3 is a flowchart illustrating the details of image recording processing according to the first embodiment;

FIG. 4 is a flowchart illustrating the details of image reproducing processing in the first and second embodiments;

FIG. 5 is a flowchart illustrating the details of image display processing in the first and second embodiments;

FIG. 6 is a flowchart illustrating the details of representative-image selection processing according to the first embodiment;

FIG. 7 is a flowchart illustrating the details of image recording processing according to the second embodiment; and

FIG. 8 is a flowchart illustrating the details of representative-image selection processing according to the second embodiment.

### BEST MODE FOR CARRYING OUT THE INVENTION

### First Embodiment

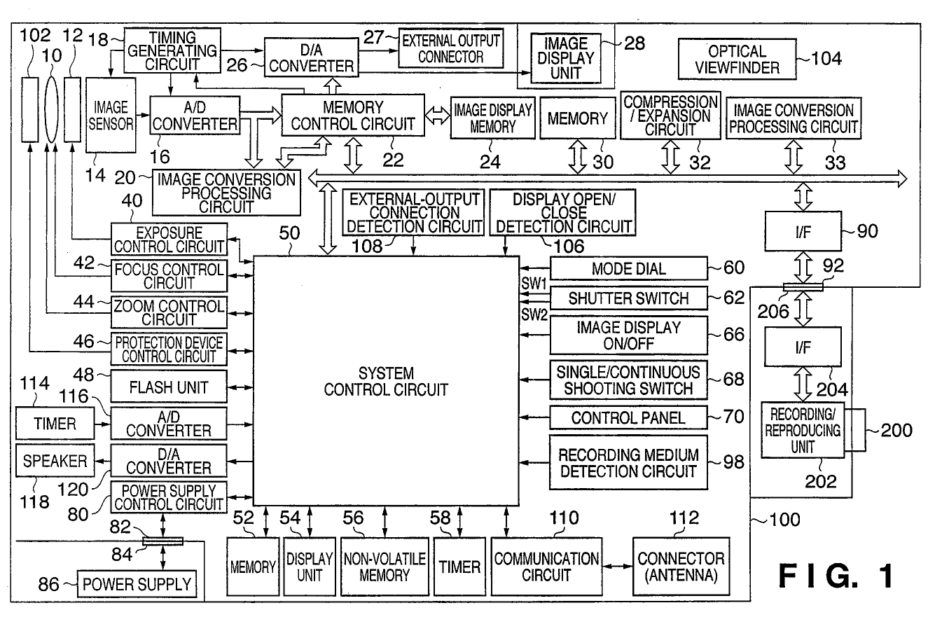

An image pickup apparatus according to a first embodiment of the present invention will be described with reference to the accompanying drawings. FIG. 1 is a block diagram illustrating the functional configuration of an image pickup apparatus according to this embodiment to which the present invention is applicable. Illustrated in FIG. 1 are an image pickup apparatus 100, such as a digital camera; an shooting lens 10; a shutter 12 having an iris function; an image sensor 14, which is constituted by a CCD (Charge-Coupled Device) or the like, for converting an optical object image to an electrical signal; and an A/D (Analog to Digital) converter 16 for converting an analog image signal, which corresponds to the optical object image that is output from the image sensor 14, to digital image data.

A timing generating circuit 18 supplies various clock signals and various control signals to the A/D converter 16 and to a D/A (Digital to Analog) converter 26, described later. The timing generating circuit 18 is controlled by a memory control circuit 22 and system control circuit 50.

An image conversion processing circuit 20 applies specific image conversion processing, such as pixel interpolation processing or color conversion processing, to image data from the A/D converter 16 or to image data from the memory control circuit 22. Further, the image conversion processing circuit 20 executes prescribed processing using image data obtained by shooting. Based upon the results of processing, a system control circuit 50 executes so-called TTL (Through The Lens) AF (Auto Focus) processing for controlling an exposure control circuit 40 and focus control circuit 42. The system control circuit 50 further executes AE (Auto Exposure) processing and EF (Electronic Flash) processing. The image conversion processing circuit 20 executes prescribed processing using image data obtained by shooting and executes TTL-type AWB (Auto White Balance) processing based upon the results of processing obtained.

The memory control circuit 22 controls the A/D converter 16, timing generating circuit 18, image conversion processing circuit 20, an image display memory 24, the D/A converter 26, a memory 30 and a compression/expansion circuit 32.

Image data from the A/D converter 16 is written to the image display memory 24 or memory 30 via the image conversion processing circuit 20 or memory control circuit 22, or image data from the A/D converter 16 is written directly to the image display memory 24 or memory 30 via the memory control circuit 22.

Further provided is an image display unit 28, which comprises a TFT-LCD (Thin Film Transistor-Liquid Crystal Display) or the like. Image data for display purposes that has been written to the image display memory 24 is displayed by the image display unit 28 via the D/A converter 26. If image data being captured by the image sensor 14 is displayed sequentially using the image display unit 28, then it is possible to implement an electronic viewfinder function.

Further, the image display unit 28 is capable of having its display turned ON and OFF at will in response to a command from the system control circuit 50. When the display is turned OFF, power consumption by the image pickup apparatus 100 can be reduced by a wide margin.

The image display unit 28 is joined to the image pickup apparatus 100 by a rotatable hinge. Accordingly, by freely setting the orientation and angle, the image display unit 28 can be used to present various displays, such as that of an electronic viewfinder function, playback display function, and mode and status of the image pickup apparatus 100.

Furthermore, it is possible for the display screen portion of the image display unit 28 to be faced toward the side of the main body of image pickup apparatus 100 and closed. In this case, the closed state is sensed by a display open/close detection circuit 106 so that the display operation of the image display unit 28 can be halted.

The memory 30, which is for the purpose of storing still image data or moving image data that has been captured, has enough storage capacity to store a certain number of frames of still image data or moving image data shot over a certain length of time. In this way it is possible to write a large quantity of image data to the memory 30 at high speed even in case of continuous shooting or stitch shooting where a plurality of frames of still image data are shot continuously. Further, the memory 30 can be used as a working area of the system control circuit 50.

The compression/expansion circuit 32 is a circuit for compressing or expanding image data by ADCT (Adaptive Discrete Cosine Transform). Image data that has been stored in the memory 30 is read in to the compression/expansion circuit 32 and subjected to compression or expansion processing. The image data whose processing has been completed in the compression/expansion circuit 32 is then written to the memory 30. Also provided is an image conversion processing circuit 33.

The exposure control circuit 40, which controls the shutter 12 having the iris function, also implements a flash exposure control function by cooperating with a flash unit 48. The focus control circuit 42 controls the focusing of the shooting lens 10.

The exposure control circuit 40 and focus control circuit 42 are controlled using the TTL scheme. The system control circuit 50 controls the exposure control circuit 40 and focus control circuit 42 based upon results of processing obtained by processing the captured image data using the image conversion processing circuit 20.

A zoom control circuit 44 controls zooming of the shooting lens 10, and a protection device control circuit 46 control the operation of a protection device 102.

The system control circuit 50 controls the overall image pickup apparatus 100. A memory 52 stores constants, variables and programs for operation of the system control circuit 50.

A display unit 54 has a liquid crystal display and speakers, etc., for displaying operating status and messages, etc., using text, images and voice, etc., in accordance with execution of a program by the system control circuit 50. These are placed at one or several easy-to-see locations near the control panel of the image pickup apparatus 100 and are implemented by combining an LCD, LED (Light-Emitting Diode) and sound-emitting device, by way of example.

Among the displays presented on the display unit 54, those displayed by an LCD are a single/continuous shooting display, self-timer display, display of image compression rate, display of number of recordable pixels, display of number of recordable frames, display of number of frames capable of being images, and display of shutter speed, etc. Further examples are a display of f-stop value, an exposure correction display, a flash display, a redeye reduction display, a macrophotography display, a buzzer setting display, a display of remaining clock battery power, and a remaining battery display, etc.

Also presented are various error displays, an information display based upon numerals of a plurality of digits, a display indicating whether a recording medium 200, which is removably loaded in a recording/reproducing unit 202, has been loaded or not, a display indicating operation of a communication interface, and a date/time display. Among the displays presented on the display unit 54, those displayed in an optical viewfinder 140 include an in-focus display, a camera-shake warning display, a flash charging display, a shutter-speed display, an f-stop value display and an exposure correction display, etc.

A non-volatile memory 56 is capable of being erased and recorded on electronically. An example of such a memory that can be used is an EEPROM (Electronically Erasable Programmable Read-Only Memory). Operating units 60, 62, 64, 66, 68 and 70 are for inputting various operating commands to the system control circuit 50. These are, singly or in combination, switches and dials, a pointing device based upon visual detection and a speech recognition device, etc.

These operating units will be described in detail. The operating unit 60 is a mode dial that makes various settings in response to the turning of a mode dial. That is, by being rotated, this device turns power on and off and switches among and sets various function modes such as an automatic shooting mode, shooting mode, panorama shooting mode, playback mode, multiple-screen playback/erase mode and PC (Personal Computer) connection mode, etc.

The operating unit 62 is a shutter switch 62 that is turned ON and outputs a signal SW1 in response to partial depression, i.e., half depression, of a shutter button (not shown). The signal SW1 instructs the start of operations such as autofocus (AF) processing, automatic exposure (AE) processing, automatic white balance processing (AWB) and electronic flash processing.

A lens in a lens barrel is moved to the in-focus position when AF processing is executed. When a flash emission has been ordered by EF processing, the system control circuit 50 instructs the flash unit 48 to perform a pop-up operation if the flash unit has not popped up. In response, the flash unit 48 performs the flash pop-up operation. A force acts upon the image pickup apparatus 100 owing to the pop-up operation of the flash. As a result, the image pickup apparatus 100 vibrates. Before flash pop-up is performed, therefore, the system control circuit 50 instructs the zoom control circuit 44 to adjust the position of the lens 10 in such a manner that the lens 10 will not be shifted by vibration of the image pickup apparatus 100. The system control circuit 50 thenceforth instructs the flash unit 48 to perform the flash pop-up operation. Further, after the flash pop-up operation has been completed, the system control circuit 50 instructs the zoom control circuit 44 to restore the lens 10 by the amount moved by the adjustment.

Further, the shutter switch 62 is turned ON and outputs a signal SW2 in response to full depression of the shutter button. In response to the signal SW2, a signal, i.e., image data read out of the image sensor 14 is written to the memory 30 via the memory control circuit 22. The start of a series of processing operations is instructed. These include processing that uses processing executed by the image conversion processing circuit 20 and memory control circuit 22, and recording processing for reading image data out of memory 30, performing compression by the compression/expansion circuit 32 and writing the image data to the recording medium 200.

The operating unit 66 is an ON/OFF switch 66 that is capable of turning the image display unit 280N or OFF. When shooting is performed using the optical viewfinder 104, this function makes it possible to conserve power by cutting off the supply of current to the image display unit 28 comprising the TFT-LCD, etc.

The operating unit 68 is a single/continuous shooting switch 68. There are two modes in a case where the signal SW2 has been output by pressing the shutter switch 62. Specifically, it is possible to set a single shooting mode in which a single item of image data is shot and a standby state established, and a continuous shooting mode in which shooting is performed continuously while the signal SW2 is being output by pressing the shutter switch 62 continuously.

Reference numeral 70 denotes a control panel comprising various buttons and a touch-sensitive panel. The control panel 70 includes a menu button, setting button, macro button, multiple-screen playback page-change button, flash setting button and self-timer changeover button.

The control panel further includes a menu moving+(plus) button, a menu moving−(minus) button, a shooting image quality selection button, exposure correction button, date/time setting button and panorama mode setting button. Also included is a selection/changeover button for selecting and changing over various functions when an shooting operation and playback operation are performed. Further included are a decide/execute button for deciding and executing various functions when shooting and playback are performed in the panorama mode, etc., and an image display ON/OFF switch for turning the image display unit 28 ON and OFF.

Further included are a quick-review ON/OFF switch that sets a quick-review function for automatically reproducing image data immediately after shooting; a compression mode switch for selecting the compression rate of JPEG compression or for selecting a CCD-RAW mode in which the signal from the image sensor 14 is recorded on the recording medium 200 as is in digital form; a playback mode switch that is capable of setting various function modes such as the playback mode, mode for displaying a series of image data, multiple-screen playback/erase mode and PC connection mode; and a playback switch which, in a shooting mode, instructs the start of a playback operation in which the captured image is read out of memory 30 or recording medium 200 and is displayed by the image display unit 28.

A power supply control circuit 80 is constituted by a switch circuit, etc., for changing over among a remaining-battery detection circuit, DC-DC converter and electrifying block. Whether a battery has been loaded or not is detected, the type of loaded battery is detected and so is the remaining amount of battery power. On the basis of the result of detection and a command from the system control circuit 50, a DC-DC converter is controlled and the necessary voltage is supplied to each unit for the required length of time.

Reference numerals 82, 84 denoted connectors. A power supply 86 comprises a primary battery such as an alkali battery or lithium battery, a secondary battery such as a NiCd battery, NIMH battery or Li battery, or an AC adapter. An interface 90 is for interfacing the recording medium 200, such as a memory card or hard disk, and a connector 92 is for connecting to the recording medium 200 such as the memory card or hard disk. A recording medium detection circuit 98 detects whether the recording medium 200 has been attached to the connector 92.

In this embodiment, the interface and the connector for mounting the recording medium 200 are described as having two channels. Of course, the interface and connector for attaching the recording medium 200 may have any number of channels, such as a single channel or multiple channels. It is also permissible to combine an interface and connector having different specifications.

The interface and connector used may comply with the specifications of a PCMCIA card or various memory cards, etc. Furthermore, the interface 90 and the connector 92 used can comply with the specifications of a PCMCIA card or various memory cards, etc. In this case, various communication cards such as a LAN card, modem card, USB card, IEEE-1394 card, P1284 card, SCSI card and PHS communication card are connected. It is also possible to transfer image data and management information, which has been appended to the image data, among other computers and peripheral equipment such as printers.

The protection device 102 covers the pickup unit inclusive of the lens 10 of image pickup apparatus 100, thereby preventing the pickup unit from being contaminated or damaged.

It is possible to perform shooting using only the optical viewfinder 104 without using the electronic viewfinder function afforded by the image display unit 28. Further, some of the functions of the display unit 54, e.g., the in-focus display, camera-shake warning display, flash charging display, shutter-speed display, f-stop value display and exposure correction display, etc., are placed within the optical viewfinder 104.

The display open/closed detection circuit 106 is capable of detecting whether the image display unit 28, which is adapted so as to be rotatable, is in the accommodated state with the display portion of the image display unit 28 facing inward toward the side face of the image pickup apparatus 100. If it is detected that the image display unit 28 is in the accommodated state, it is possible to halt the display operation of the image display unit 28 and prevent unnecessary power consumption.

A communication circuit 110 has various communication functions such as those compliant with RS232, USB, IEEE 1394, P1284, SCSI, modem, LANs and wireless communications. Numeral 112 denotes a connector or, in case of wireless communication, an antenna, for connecting the image pickup apparatus 100 to another apparatus by the communication circuit 110. A memory card or hard disk, etc., can be used as the recording medium 200. Provided for the recording medium 200 are the recording/reproducing unit 202, which is constituted by a semiconductor memory or magnetic disk, etc., an interface 204 for interfacing the image pickup apparatus 100, and a connector 206 for connecting to the image pickup apparatus 100.

Connected to the system control circuit 50 are a microphone 114 via an A/D converter 116 and a speaker 118 via a D/A converter 120.

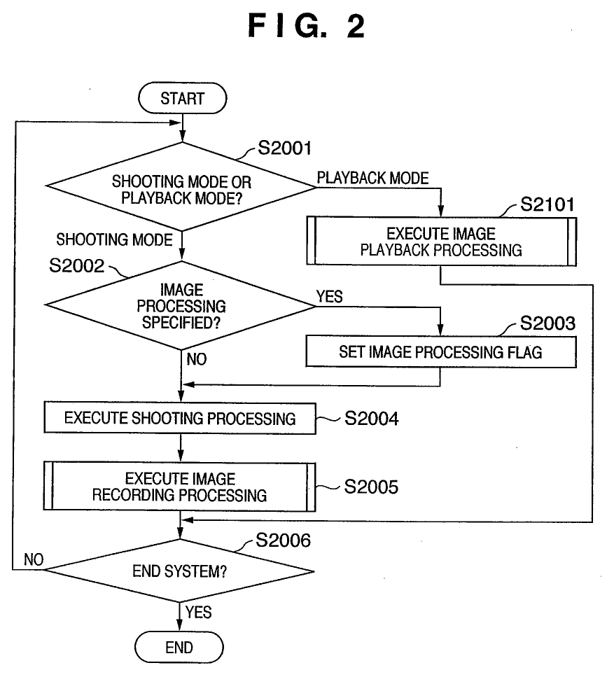

FIG. 2 is a flowchart useful in describing the operation of the first embodiment of the present invention. Reference will be had to FIG. 2 to describe the operation of the first embodiment illustrated in FIG. 1. The operation of the overall image pickup apparatus 100 is controlled by the system control circuit 50.

Following start-up of the apparatus, it is determined at step S2001 whether the shooting mode or playback mode has been selected. Control proceeds to step S2002 if the shooting mode has been selected and to step S2101 if the playback mode has been selected.

If it is determined at step S2001 that the shooting mode has been selected, then control proceeds to step S2002 and it is determined whether specific image processing has been specified. If specific image processing has been specified (“YES” at step S2002), then control proceeds to step S2003. Here an image processing flag is set and then control proceeds to step S2004. However, if it is found at step S2002 that image processing has not been specified (“NO” at step S2002), then control proceeds to step S2004 and shooting processing is executed. In this embodiment of the present invention, shooting processing can be implemented in a variety of forms.

Image data obtained by shooting at step S2004 at which shooting processing is executed is recorded temporarily in memory 30. The image data that has been recorded in the memory 30 is subjected to any compression processing or, if the image processing flag has been set, to the specified image conversion processing. After this processing is executed, control proceeds to step S2005, where the processed image data is recorded on the recording medium 200. The details of the image recording processing at step S2005 will be described later.

Next, after the image data has been recorded on the recording medium 200 at step S2005, control proceeds to step S2006, where it is determined whether system termination has been selected. If termination has been selected (“YES” at step S2006), control returns to step S2001 and processing from step S2001 onward is repeated.

In this case, if it is now determined at step S2001 that the playback mode has been selected, then control proceeds to step S2101, where image playback processing is executed for reproducing the image data that has been stored on the recording medium 200. The details of the image playback processing at step S2101 will be described later.

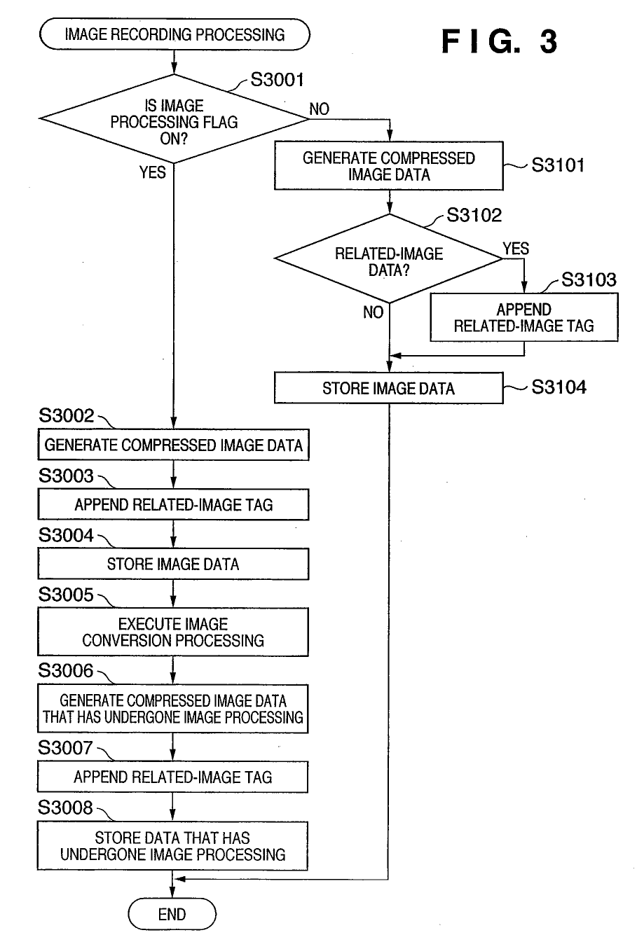

Next, the image recording processing at step S2005 of FIG. 2 will be described with reference to FIGS. 1 and 3. Image recording processing proceeds in accordance with control exercised by the system control circuit 50. Assume now that the image processing flag has been set at step S2003 in FIG. 2. In this case, it is determined at step S2003 in FIG. 3 that the image processing flag is ON. In this case, therefore, control proceeds to step S3002 by reason of the fact that specific image processing has been specified. However, if it is determined at step S3001 that the image processing flag is not ON, then control proceeds to step S3101.

At step S3101, use is made of the compression/expansion circuit 32 to read out captured image data that has been stored in memory 30, compress the data at a specified compression rate and record the data again in a vacant area of the memory 30. Control then proceeds to step S3102, at which it is determined whether the image data undergoing processing is part of a series of related image data.

If the image data undergoing processing is part of a series of related image data (“YES” at step S3102), then control proceeds to step S3103. Here a related-image tag, which indicates that the data is part of a series of related image data, is appended to the compressed image data that has been stored in the memory 30. Control then proceeds to step S3104. However, if the image data undergoing processing is not part of a series of related image data (“NO” at step S3102), then the related-image tag is not appended and control proceeds to step S3104. Here the compressed image data that has been recorded in the memory 30 is recorded on the recording medium 200 and this series of processing steps is terminated. In this case, when recording is performed at step S3104, the fact that recording is in progress may be displayed utilizing an LED (not shown) or the image display unit 28.

Next, if it is determined at step S3001 that the image processing flag is ON, then control proceeds to step S3002 and the original image data is recorded on the recording medium 200. To accomplish this, first the captured image data that has been stored in the memory 30 is read out, the image data is compressed at the specified compression rate and the compressed data is recorded again in a vacant area of the memory 30. Next, at step S3003, the related-image tag, which indicates that the data is part of a series of related image data, is appended to the compressed image data that has been stored in the memory 30. Control then proceeds to step S3004. The compressed image data to which the related-image tag has been appended is then recorded on the recording medium 200 as original image data with the appended related-image tag. When recording is performed at step S3004, the fact that recording is in progress may be displayed utilizing an LED (not shown) or the image display unit 28.

Next, the processing set forth below is executed in order to subject the same image data to image conversion processing and record the processed data on the recording medium 200. Specifically, first, at step S3005, the captured image data that has been recorded in memory 30 is read out again, the specified image conversion processing is executed utilizing the image conversion processing circuit 33, and the processed image data is recorded in a vacant area of the memory 30 again as image data whose image processing has been completed. Next, at step S3006, this processed image data that has been stored in the memory 30 is read out, compressed at the specified compression rate and recorded in a vacant area of memory 30 again.

This is followed by step S3007, at which the related-image tag, which indicates that the data is part of a series of related image data, is appended to the compressed image data that has been stored in the memory 30, and then by step S3008, at which the image data that has undergone image processing and has the related-image tag appended thereto is recorded on the recording medium 200. This series of processing steps then ends. The related-image tag includes, as a parameter, information indicating the type of image conversion processing, such as switch color, one-point color and redeye correction, that was applied to the image at step S3006. When recording is performed at step S3008, the fact that recording is in progress may be displayed utilizing an LED (not shown) or the image display unit 28.

The original image data with the related-image tag appended thereto can thus be stored on the recording medium 200 and it is also possible to store the image data that has undergone image processing, has the related-image tag appended thereto and has been subjected to an image conversion.

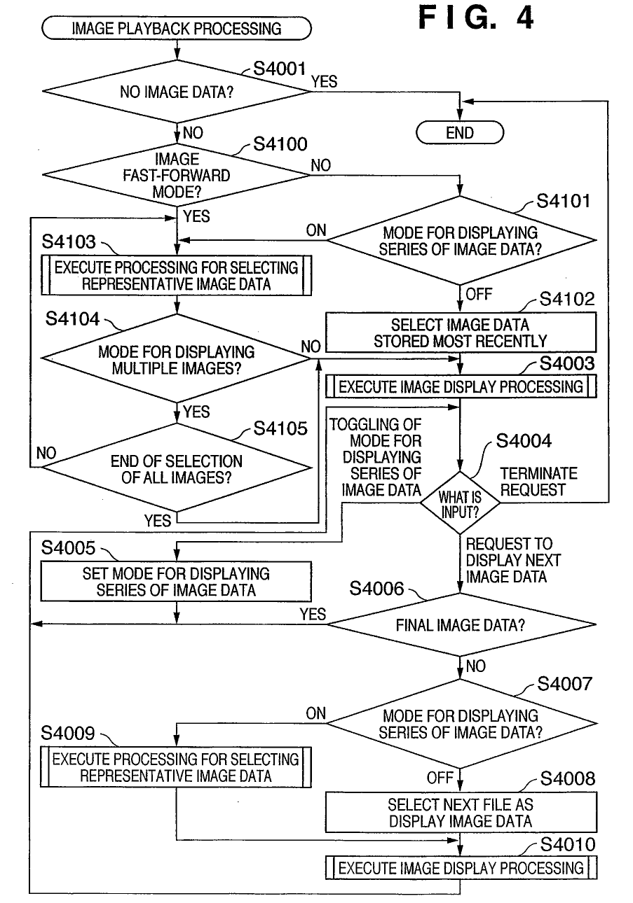

The image playback processing of step S2101 in FIG. 2 will now be described with reference to FIGS. 1 and 4. The system control circuit 50 extracts various image data that has been stored on the recording medium 200 and reproduces the image data. If at this time it is determined at step S4001 that there is no image data recorded on the recording medium 200, then the system control circuit 50 halts playback processing without reproducing image data. At this time a display indicating that no image data exists may be presented on the image display unit 28. If image data has been recorded on the recording medium 200, on the other hand, then control proceeds to step S4100.

If it is determined at step S4100 that the image-data display mode is an image fast-forward mode based upon rotation of a dial on the control panel 70 or continuous depression of an image fast-forward key, etc., then control proceeds to step S4103. If it is determined that the mode is not the image fast-forward mode, then control proceeds to step S4101. The details of processing for selecting representative image data at step S4103 will be described later.

At step S4101, whether the image pickup apparatus 100 is in a mode for displaying a series of image data is checked (i.e., whether this mode is ON is checked). If the mode for displaying a series of image data is ON, then control proceeds to the processing of step S4103 for selecting representative image data. Here representative image data of the series of image data is selected as display image data. Control then proceeds to step S4104. Here it is determined whether the image display mode is a multiple-image display mode specified by operation of a key on the control panel 70. If it is determined that the mode is not the multiple-image display mode, control proceeds to step S4003. If it is determined that the mode is the multiple-image display mode, then control proceeds to step S4105 and it is determined whether selection of all of the plurality of images has ended. If selection of all images has ended, control proceeds to step S4003. If selection of all images has not ended, then control returns to step S4103 and processing for selecting representative image data is executed again.

If it is found at step S4101 that the mode for displaying a series of image data is OFF, control proceeds to step S4102. Of the image data that has been recorded on the recording medium 200, the image data stored most recently is selected as display image data.

Control then proceeds to step S4003, where image display processing is executed. This processing displays the image data, which has been selected at step S4102 or step S4103, on the image display unit 28. The details of the image display processing at step S4003 will be described later.

Next, at step S4004, the system control circuit 50 monitors inputs, namely whether there is an input from the control panel 70 or an input from the timer 58, etc. Control proceeds to step S4005 in a case where a toggle operation of the mode for displaying a series of image data has been selected. On the other hand, in a case where the input is a request to display the next item of image data, control proceeds to step S4006. In a case where the input is a request to terminate playback, the processing for reproducing image data is terminated.

In a case where the toggle operation of the mode for displaying a series of image data has been selected at step S4004, a toggle operation (if the present setting is ON, then the setting is turned OFF, and if the present setting is OFF, then the setting is turned ON) of the mode for displaying a series of image data is set at step S4005. Control then returns to step S4004 and the system waits for an input.

Twice depressions of a special-purpose operating member for displaying a series of images or of a playback mode button on the control panel 70 may be considered as an input at step S4004. In another conceivable method, prolonged depression of an operating member the same as the image fast-forward button for displaying the next image is an input of the toggle operation and designation of a request to display the next image. In another conceivable method, an input from the timer 58 indicating that a fixed time has elapsed is received and this input is accepted as a request to display the next image. Any of these methods mentioned above can be applied as an embodiment of the present invention.

If the input at step S4004 is a request to display the next item of image data, then control proceeds to step S4006. If the image data presently being displayed is found to be the final image data (“YES” at step S4006), control returns to step S4004. If the image data presently being displayed is found not to be the final image data (“No” at step S4006), then control proceeds to step S4007.

If it is determined at step S4007 that the mode for displaying a series of image data is ON, then control proceeds to step S4009, where image data for which the next representative image data has been stored is selected as the display image data. The details of processing for selecting representative image data will be described later.

If it is determined at step S4007 that the mode for displaying a series of image data is OFF, then control proceeds to step S4008. Here the next item of data is selected as the display image data. The selection of the next item of image data may be based upon the ascending or descending order of the creation dates of image data or the ascending or descending order of file names. Selection by either of these methods is permissible.

After the processing for selecting representative image data at steps S4008, S4009, control proceeds to step S4010, where processing for displaying the next item of image data is executed. The details of image display processing at step S4010 will be described next.

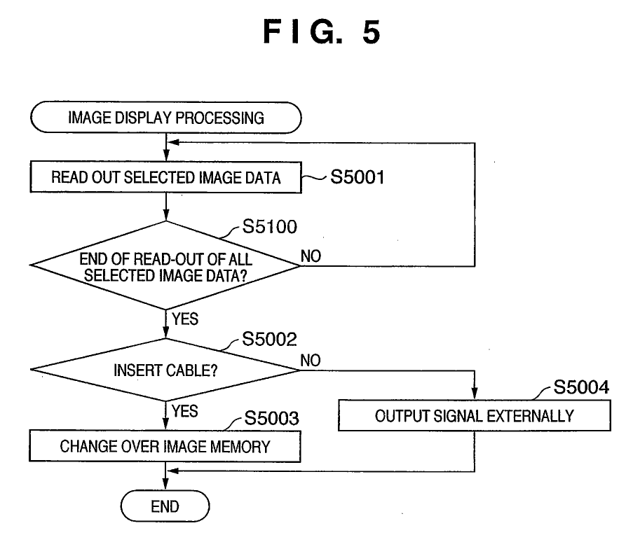

FIG. 5 is a flowchart illustrating the image display processing of steps S4003 and S4010 in FIG. 4. At step S5001, after the start of processing, the system control circuit 50 reads the image data, which has been stored on the recording medium 200, from the recording medium 200 to a blank area of memory 30 and makes a conversion to a format for image display. Next, at step S5100, it is determined whether all selected images have been read out and converted to the format for the image display. If it is determined at step S5100 that read-out of all image data has ended, control proceeds to step S5002. If it is determined that read-out of all image data has not ended, then control returns to step S5001, image data is read out and a conversion to the display format is made. If it is determined at step S5002 that a cable has been inserted into an external output connector 27, then control proceeds to step S5004. If it is determined that the cable has not been inserted, control proceeds to step S5003 and processing is then terminated.

At step S5003, the image data written to the prescribed area of memory 30 at step S5001 is read out, transferred to the image display memory 24 and the image represented by the data is displayed on the image display unit 28.

At step S5004, image data written to the prescribed area of memory 30 at step S5001 is read out, transferred to the image display memory 24 and output to the external output connector 27.

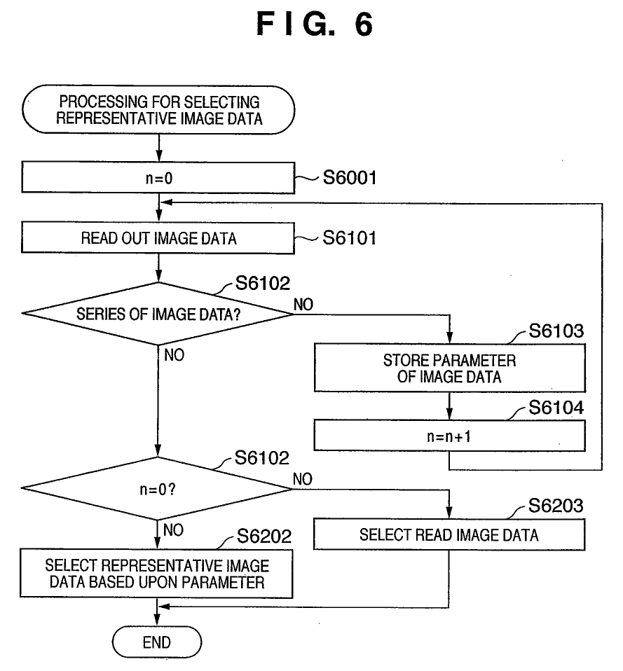

FIG. 6 is a flowchart illustrating the details of processing of FIG. 4 for selecting representative image data. At step S6001, the system control circuit 50 reserves a counter n, which is for counting the number of items of a series of image data, in a vacant area of the memory 30 and initializes the count to zero (n=0). Then, at step S6101, the system control circuit 50 reads out the image data that has been stored on the recording medium 200 and, at step S6102, determines whether the read image data is a series of image data. If it is determined that the read image data is a series of image data, control proceeds to step S6103. Here the system control circuit 50 stores the parameter of the read image data in a vacant area of the memory 30. If it is determined that the read image data is not a series of image data, then control proceeds to step S6201.

The system control circuit 50 increments the counter n of the series of image data at step S6104 and control returns to step S6101. It is determined at step S6201 whether the counter n of the series of image data indicates zero (0). Control proceeds to step S6202 if the counter n indicates zero (0) and to step S6203 if the counter n does not indicate zero (0).

At step S6202, the system control circuit 50 selects representative image data upon checking the parameter of the image data stored in the memory 30 at step S6103. Shooting parameters include the creation date and time of the image data, the exposure value of the image data, the focus value of the image data, and the type of image conversion processing such as switch color and one-point color. The selection of representative image data is performed based upon a group of a series of image data that contains this image data.

For example, consider a shooting case where image conversion processing is executed at the time of shooting, image data different from the captured image data is generated at the time of shooting, and two items of image data, namely the captured image data and the image data that has undergone image conversion processing, are stored at the time of shooting. In this case, the image data that has undergone the image conversion processing is selected as the representative image data.

Further, in a case where the data is a series of image data composed of a group of image data that has been captured continuously as by continuous shooting, there are instances where the image data having the oldest recording date and time is selected as the representative image data. Alternatively, there can also be cases where a series of image data that has been generated through blanket shooting such as AEF or AFB, specifically image data having values near the center of these exposure values or focus values, is selected as the representative image data.

Furthermore, in a series of image data used in image synthesis, such as stitch shooting, image data stored earliest in terms of time is selected as the representative image data. These are merely examples of embodiments of a method of selecting representative image data.

### Second Embodiment

A second embodiment of the present invention will be described with reference to the drawings. FIG. 1 is a diagram illustrating the configuration of the embodiment of the present invention. The detailed description relating to FIG. 1 has been rendered in the section pertaining to the first embodiment.

The operation of the second embodiment will be described by again using FIG. 2 used in the description of the first embodiment of the invention. That is, FIG. 2 will be used also as a flowchart for describing the basic operation of the second embodiment of the invention.

In the second embodiment as well, after start-up the system control circuit 50 advances control to step S2002 if the shooting mode has been selected at step S2001. If the playback mode has been selected, then control proceeds to step S2101.

If the shooting mode has been selected, control proceeds to step S2003 in a case where image processing has been specified at step S2002. An image processing flag is set at step S2003 and then control proceeds to step S2004.

If image conversion processing has not been specified, control proceeds to step S2004, where shooting processing is executed. Although shooting processing can be implemented in various forms, any method may be adapted.

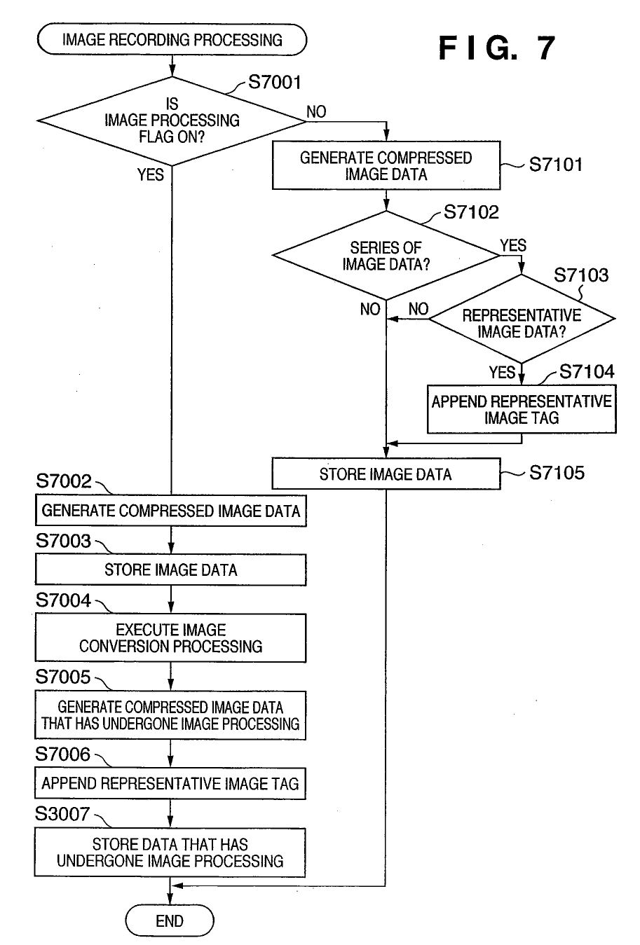

The image captured at the shooting processing step S2004 is recorded in the memory 30. The image data that has been recorded in the memory 30 is subjected to any compression processing or, if the image processing flag has been set, to image conversion, etc. The resultant data is recorded on the recording medium 200 (step S2005). The details of the image recording processing will be described later with reference to FIG. 7.

If system termination has been selected at step S2006, then the system processing ends. If system termination has not been selected, then control returns to step S2001 and processing is continued. If playback has been selected at step S2001, control proceeds to step S2101, where image playback processing is executed for reproducing the image data that has been stored on the recording medium 200. The details of the image playback processing at step S2101 are as described in the first embodiment.

The image recording processing at step S2005 of FIG. 2 in the second embodiment will be described with reference to FIGS. 1 and 7.

If the image processing flag has been turned ON at step S2003 in FIG. 2, then the system control circuit 50 determines at step S7001 that image processing has been specified and control proceeds to step S7002. If the image processing flag has not been turned ON, however, then control proceeds to step S7102.

At step S7101, use is made of the compression/expansion circuit 32 to read out captured image data that has been stored in memory 30, compress the data at a specified compression rate and record the data again in a vacant area of the memory 30. If the image data undergoing processing is part of a series of related image data (“YES” at step S7102), control proceeds to step S7103 and it is further determined whether the data is representative image data.

Whether the data is representative image data differs depending upon the method of generating the series of images. For example, consider a shooting case where image conversion processing is executed at the time of shooting, image data different from the captured image data is generated at the time of shooting, and two items of image data, namely the captured image data and the image data that has undergone image conversion processing, are stored at the time of shooting. In this case, the application of image conversion processing is the objective and the original captured image data has been stored for the purpose of checking image data that has not been subjected to an image conversion. Image data that has undergone image conversion processing, therefore, is adapted as representative image data.

Further, consider a case where the data is a series of image data composed of a group of image data that has been captured continuously as by continuous shooting. That is, there are cases where image data having the oldest recording date and time is selected as the representative image data. Furthermore, there are also cases where a series of image data that has been generated through blanket shooting such as AEF or AFB, specifically image data having values near the center of set values of these exposure values or focus values, is adopted as the representative image data. Accordingly, the result of approximate set values can be predicted to some extent from the representative image data.

Furthermore, in a series of image data used in image synthesis, such as stitch shooting, image data stored earliest (at the beginning) in terms of time is selected as the representative image data. These are merely examples of embodiments of a method of selecting representative image data.

If the image data is representative image data (“YES” at step S7103), then control proceeds to step S7104. Here a tag indicative of representative image data is appended to the compressed image data that has been stored in the memory 30. If the image data is not representative image data (“NO” at step S7103), then control proceeds to step S7105. Here the compressed image that has been stored in the memory 30 is recorded on the recording medium 200. When recording is performed at step S7105, the fact that recording is in progress may be displayed utilizing an LED (not shown) or the image display unit 28.

Next, at step S7002, the system control circuit 50 reads out the captured image data that has been stored in the memory 30, compresses the image data at the specified compression rate and again records the compressed image data in a vacant area of the memory 30. Then, at step S7003, the system control circuit 50 records the compressed image data, which has been recorded in the memory 30, on the recording medium 200. When recording is performed at step S7003, the fact that recording is in progress may be displayed utilizing an LED (not shown) or the image display unit 28.

Next, the captured image data recorded in the memory 30 is subjected to any specified image conversion at step S7004 utilizing the image conversion processing circuit 33, and the image data obtained by the conversion is recorded in a vacant area of the memory 30. Next, at step S7005, this image data that has undergone conversion processing and been stored in the memory 30 is compressed at any specified compression rate and recorded in a vacant area of memory 30.

This is followed by step S7006, at which the representative-image tag, which indicates that the data is representative image data, is appended to the compressed image data that has been stored in the memory 30, and then by step S7007, at which the compressed image data that has been recorded in the memory 30 is recorded on the recording medium 200. When recording is performed at step S7006, the fact that recording is in progress may be displayed utilizing an LED (not shown) or the image display unit 28.

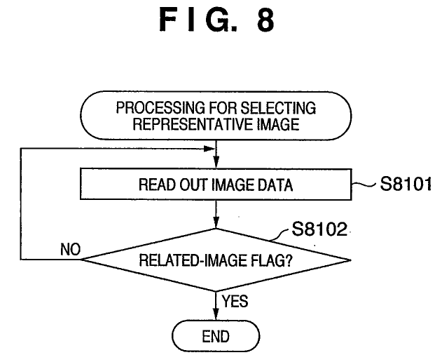

FIG. 8 is a diagram illustrating the details of steps S4103, S4009 of processing for selecting representative image data shown in FIG. 4. The system control circuit 50 reads out the image data, which has been stored on the recording medium 200, to a vacant area of the memory 30 at step S8001 and determines at step S8102 whether the representative-image tag has been appended to the read image data. If it is determined that the representative-image tag has been appended to the read image data, then processing is terminated. If it is determined that the representative-image tag has not been appended to the read image data, then control returns to step S8101.

Thus the first and second embodiments of the invention operate at set forth above.

It goes without saying that the object of the invention can also be attained also by supplying a storage medium storing the program codes of the software for implementing the functions of the foregoing embodiments to a system or an apparatus, reading the program codes with a computer (or a CPU or MPU) of the system or apparatus from the storage medium, and then executing the program codes. In this case, the program codes per se read from the storage medium implement the functions of the embodiments and the storage medium storing the program codes constitutes the invention.

Examples of storage media that can be used for supplying the program code are a flexible disk, hard disk, optical disk, magneto-optical disk, CD-ROM, CD-R, magnetic tape, non-volatile type memory card or ROM, etc. Further, there are also cases where the functions of the foregoing embodiments are implemented by executing program code read by a computer.

However, it goes without saying that the present invention covers a case where an operating system or the like running on the computer performs a part of or the entire actual processing based upon the designation of program codes and implements the functions according to the embodiments. It goes without saying that the present invention further covers a case where, after the program codes read from the storage medium are written to a memory provided on a function expansion board inserted into the computer or a memory provided in a function expansion unit connected to the computer, a CPU or the like contained in the function expansion board or function expansion unit performs a part of or the entire actual processing based upon the designation of program codes and implements the functions of the above embodiments by this processing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-014300 filed Jan. 23, 2006 and Japanese Patent Application No. 2006-356091 filed Dec. 28, 2006, which are hereby incorporated by reference herein in their entirety.

1. An image pickup apparatus comprising:
an image pickup unit adapted to obtain image data of an object;
an image processing unit adapted to execute image processing to an image data obtained from the image pickup unit to obtain an processed image data;
a recording unit adapted to record both the image data obtained from the image pickup unit and the processed image data as related image data; and
a display control unit adapted to control to display the processed image data recorded by the recording unit on a display unit, and to control not to display on the display unit the image data related to the processed image data.

2. The image pickup apparatus according to claim 1, wherein
said image processing unit executes image processing instructed from a user onto the image data obtained from the image pickup unit.

3. The image pickup apparatus according to claim 1, wherein
said image processing unit executes image processing for color instructed from a user onto the image data obtained from the image pickup unit.

4. The image pickup apparatus according to claim 1, wherein
said image processing unit executes image processing for red-eye reduction process instructed from a user onto the image data obtained from the image pickup unit.

5. The image pickup apparatus according to claim 1, further comprising:
a selection unit adapted to select the processed image data to be displayed on the display unit.

6. The image pickup apparatus according to claim 1, wherein
said image processing unit executes the image processing when a fast-forward operation for the recording unit is instructed by a user.

7. The image pickup apparatus according to claim 1, wherein
said processed image data is a set of image data obtained from the image pickup unit by sequentially shooting the object while changing shooting parameters.

8. An image pickup method comprising:
an image pickup step of obtaining image data of an object;
an image processing step of executing image processing to an image data obtained by the image pickup step to obtain an processed image data;
a recording step of recording both the image data obtained by the image pickup step and the processed image data as related image data; and
a display control step of controlling to display the processed image data recorded at the recording step on a display unit, and controlling not to display on the display unit the image data related to the processed image data.

9. The image pickup method according to claim 8, wherein
said image processing step executes image processing instructed from a user onto the image data obtained by the image pickup step.

10. The image pickup method according to claim 8, wherein
said image processing step executes image processing for color instructed from a user onto the image data obtained by the image pickup step.

11. The image pickup method according to claim 8, wherein
said processing unit executes image processing for red-eye reduction process instructed from a user onto the image data obtained by the image pickup step.

12. The image pickup method according to claim 8, further comprising:
a selection step of selecting the processed image data to be displayed on the display unit.

13. The image pickup method according to claim 8, wherein
said image processing step executes the image processing when a fast-forward operation to a recording unit is instructed by a user.

14. The image pickup method according to claim 8, wherein
said processed image data is a set of image data obtained by the image pickup step by sequentially shooting the object while changing shooting parameters.

15. A computer readable recording medium on which program causing a computer to execute the image pickup method according to claim 8 is stored.
